(19) United States
(12) Patent Application Publication
(10) Pub. No.: US 2020/0383498 A1
(43) Pub. Date: Dec. 10, 2020

(54) INFORMATION PROCESSING APPARATUS AND CONTROL METHOD THEREOF

(71) Applicant: TOSHIBA TEC KABUSHIKI KAISHA, Tokyo (JP)

(72) Inventor: Nobutomo NODERA, Izu Shizuoka (JP)

(73) Assignee: TOSHIBA TEC KABUSHIKI KAISHA, Tokyo (JP)

(21) Appl. No.: 16/713,775

(22) Filed: Dec. 13, 2019

(30) Foreign Application Priority Data
Jun. 4, 2019 (JP) 2019-104785

(51) Int. Cl. A47F 9/04; G07G 1/00; G06Q 30/06; G06Q 20/32; G06Q 20/20

(52) U.S. Cl. CPC A47F 9/048; G07G 1/0081; G06Q 20/208; G06Q 30/0635; G06Q 20/322; G06Q 30/0643

(57) ABSTRACT

An information processing apparatus includes a processing circuit. The processing circuit has programmed instructions to acquire a first number of commodities specified to be purchased based on first data acquired by a first sensor, acquire a second number of commodities stored in a storing body that stores commodities to be purchased based on second data acquired by a second sensor, compare the first number of commodities with the second number of commodities, and provide a notification to a display device in response to the first number of commodities being different that the second number of commodities.

### CROSS-REFERENCE TO RELATED APPLICATION

This application is based upon and claims the benefit of priority from Japanese Patent Application No. 2019-104785, filed Jun. 4, 2019, the entire contents of which are incorporated herein by reference.

### FIELD

Embodiments described herein relate generally to an information processing apparatus and a control method for causing a computer to function as the information processing apparatus.

### BACKGROUND

The related art involves a self-registration system that simplifies a registration operation by a store clerk at a cash register (payment place) in such a way that a customer registers sales data of a commodity by operating a scanner on a sales floor of a retail store and reading a barcode attached to the commodity to be purchased.

When this type of self-registration system is introduced in the retail store, it is necessary to prevent commodities that are not correctly registered at the sales floor from passing through the cash register without being paid for.

### DESCRIPTION OF THE DRAWINGS

FIG. 1 is an overall configuration diagram of a self-registration system according to an exemplary embodiment;

FIG. 2 is a schematic diagram illustrating a layout example of a retail store where the self-registration system is introduced;

FIG. 3 is a block diagram illustrating a main circuit configuration of a cart terminal incorporated in the self-registration system;

FIG. 4 is a perspective view illustrating an example of a cart including the cart terminal;

FIG. 5 is a block diagram illustrating a main circuit configuration of a server incorporated in the self-registration system;

FIG. 6 is a schematic diagram illustrating a principal data structure of a transaction file provided in the server;

FIG. 7 is a schematic diagram illustrating a principal data structure of a cart management table provided in the server;

FIG. 8 is a block diagram illustrating a main circuit configuration of a monitoring terminal incorporated in the self-registration system;

FIG. 9 is a schematic diagram illustrating an example of a cart terminal monitoring image displayed on a touch panel of the monitoring terminal;

FIG. 10 is a schematic diagram illustrating an example of a registered commodity list image displayed on the touch panel of the monitoring terminal;

FIG. 11 is a flowchart illustrating a principal information processing procedure executed by a processor of the cart terminal according to a control program;

FIG. 12 is a flowchart illustrating a specific procedure of “Process 1” in FIG. 11;

FIG. 13 is a flowchart illustrating a specific procedure of “Process 2” in FIG. 11;

FIG. 14 is a flowchart illustrating a principal information processing procedure executed by a camera controller of the cart terminal according to the control program;

FIG. 15 is a flowchart illustrating a main procedure of a registration start command reception process executed by a processor of the server according to the control program;

FIG. 16 is a flowchart illustrating a main procedure of a commodity registration command reception process executed by the processor of the server according to the control program;

FIG. 17 is a flowchart illustrating a main procedure of a return registration command reception process executed by the processor of the server according to the control program;

FIG. 18 is a flowchart illustrating a main procedure of a put-into command reception process executed by the processor of the server according to the control program;

FIG. 19 is a flowchart illustrating a main procedure of a take-out command reception process executed by the processor of the server according to the control program;

FIG. 20 is a flowchart illustrating a main procedure of a payment command reception process executed by the processor of the server according to the control program;

FIG. 21 is a flowchart illustrating a main procedure of a payment start command reception process executed by the processor of the server according to the control program;

FIG. 22 is a flowchart illustrating a main procedure of a payment end command reception process executed by the processor of the server according to the control program; and

FIG. 23 is a flowchart illustrating a main procedure of a timer interrupt process executed by the processor of the server.

### DETAILED DESCRIPTION

Embodiments provide an information processing apparatus capable of preventing a commodity which is not correctly registered at a sales floor from passing through a cash register without being paid for.

In general, according to one embodiment, an information processing apparatus includes first acquisition means, second acquisition means, determination means, and control means. In each case, the “means” may be a system, a unit, a device, a section, etc. The first acquisition means acquires the number of commodities stored in a storing body that stores a commodity to be purchased. The second acquisition means acquires the number of commodities specified by a specifying means for specifying the commodity to be purchased. The determination means determines whether or not to notify by comparing the number of commodities acquired by the first acquisition means with the number of commodities acquired by the second acquisition means. The control means controls notification when it is determined to notify by the determination means.

Hereinafter, an embodiment of an information processing apparatus capable of preventing a commodity which is not correctly registered at a sales floor from passing through a cash register without being paid for will be described with reference to the drawings. In the embodiment, an information processing apparatus is described that can be incorporated in a self-registration system of a retail store configured to allow a customer who uses a shopping cart to operate a cart terminal provided in the shopping cart to automatically register sales data of a commodity to be purchased at the sales floor.

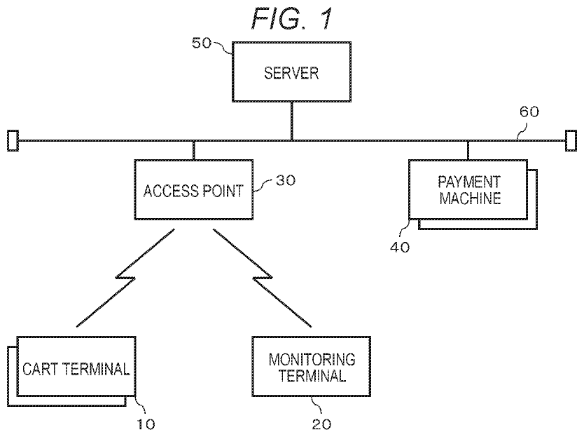

FIG. 1 is an overall configuration diagram of a self-registration system according to the embodiment. The self-registration system includes a cart terminal 10, a monitoring terminal 20, an access point 30, a payment machine 40, a server 50, and a network 60. The network 60 is, for example, a local area network (LAN). The server 50, the payment machine 40, and the access point 30 are connected to the network 60. Both the cart terminal 10 and the monitoring terminal 20 include a wireless unit and can wirelessly communicate with the access point 30. The access point 30 relays data signals exchanged between the cart terminal 10 and the monitoring terminal 20, and the server 50 and payment machine 40 connected to the network 60.

The cart terminal 10 is provided in each of a plurality of shopping carts used in the store. The monitoring terminal 20 is provided at the attendant counter. The access point 30 is provided at a predetermined location in the store. The payment machine 40 is installed at a cash register (payment place). A plurality of payment machines 40 are installed at the cash register. The server 50 is provided in a store office, for example. The location of the server 50 is not particularly limited. For example, the server 50 may be placed on a cloud service provided via the Internet.

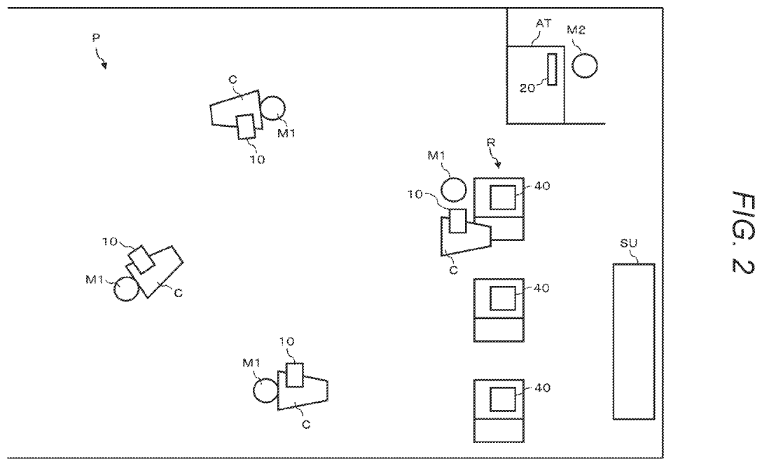

FIG. 2 is a schematic diagram illustrating a layout example of a retail store where the self-registration system is introduced. As the retail store, a store where a sales floor P and a cash register R are separated and a customer M1 who is a purchaser or a consumer uses a shopping cart C to shop, such as a supermarket or food department in a department store, is a target. Hereinafter, the shopping cart C is referred to as a cart C.

The customer M1 who uses the cart C becomes a user of the cart terminal 10 provided in the cart C. The customer M1 goes around the sales floor P together with the cart C and puts a commodity to be purchased into the cart C. In this case, the customer M1 operates the cart terminal 10 to register sales data of the commodity. After completing the shopping at the sales floor P, the customer M1 goes to the cash register R and performs payment. Payment is performed through the payment machine 40. Payment may be performed by the customer M1 operating the payment machine 40 him/herself, or by a store clerk. In the embodiment, a self-payment method in which the customer M1 operates the payment machine 40 is adopted. After the payment is completed, the customer M1 performs bagging on a sacker table SU as necessary.

An attendant counter AT is provided in the store. The attendant counter AT is in the vicinity of the cash register R. An attendant M2 who is a clerk in charge of customer service is resident at the attendant counter AT. The attendant M2 uses the monitoring terminal 20 to monitor a status of each cart terminal 10 and the payment machine 40.

Subsequently, a configuration of the cart terminal 10, the server 50, and the monitoring terminal 20 will be described. Incidentally, as the payment machine 40, an existing point-of-sale (POS) terminal already operating as a self-payment type machine model can be applied as it is. Thus, the description of the payment machine 40 is omitted.

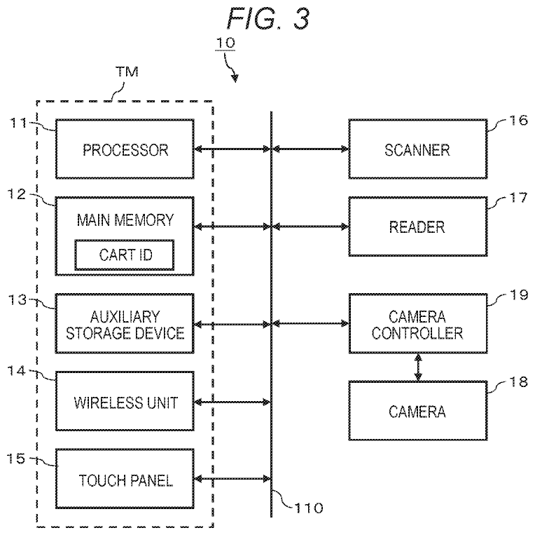

FIG. 3 is a block diagram illustrating a main circuit configuration of the cart terminal 10. The cart terminal 10 includes a processor 11, a main memory 12, an auxiliary storage device 13, a wireless unit 14 (a wireless transmitter), a touch panel 15, a scanner 16 (a first sensor, a first input device), a reader 17, a camera 18 (a second sensor, a second input device), a camera controller 19, and a system transmission path 110. The system transmission path 110 includes an address bus, a data bus, a control signal line, and the like. The cart terminal 10 connects the processor 11, the main memory 12, the auxiliary storage device 13, the wireless unit 14, the touch panel 15, the scanner 16, the reader 17, and the camera controller 19 to the system transmission path 110. The camera 18 is connected to the camera controller 19. In the cart terminal 10, a computer is configured by the processor 11, the main memory 12, the auxiliary storage device 13, and the system transmission path 110 connecting these components.

The processor 11 corresponds to a central part of the computer. The processor 11 controls each unit to implement various functions as the cart terminal 10 according to an operating system or an application program. The processor 11 is, for example, a central processing unit (CPU).

The main memory 12 corresponds to a main memory portion of the computer. The main memory 12 includes a nonvolatile memory area and a volatile memory area. The main memory 12 stores the operating system or the application program in the nonvolatile memory area. The main memory 12 stores the cart ID in the non-volatile memory area. The cart ID is a unique code set for each cart terminal 10 in order to individually identify the plurality of cart terminals 10 provided in each of the carts C. The main memory 12 stores data necessary for the processor 11 to execute processing for controlling each unit in the volatile memory area. The data may be stored in the non-volatile memory area. The main memory 12 uses the volatile memory area as a work area in which data is appropriately rewritten by the processor 11. The nonvolatile memory area is, for example, a read only memory (ROM). The volatile memory area is, for example, a random access memory (RAM).

The auxiliary storage device 13 corresponds to an auxiliary storage portion of the computer. For example, an electric erasable programmable read-only memory (EEPROM), a hard disc drive (HDD), a solid state drive (SSD), or the like can be the auxiliary storage device 13. The auxiliary storage device 13 stores data used when the processor 11 performs various processes, data generated by the processes in the processor 11, and the like. The auxiliary storage device 13 may store the application program described above.

The application program stored in the main memory 12 or the auxiliary storage device 13 includes a control program described regarding information processing executed in the cart terminal 10. A method for installing the control program in the main memory 12 or the auxiliary storage device 13 is not particularly limited. The control program can be installed in the main memory 12 or the auxiliary storage device 13 by being recorded on a removable recording medium, or distributed by communication via a network. The recording medium may be in any form as long as it can store a program and can be read by the apparatus, such as a CD-ROM or a memory card.

The wireless unit 14 performs wireless data communication with the access point 30 according to a wireless communication protocol.

The touch panel 15 is a device including both an input device and a display device of the cart terminal 10. The touch panel 15 detects a touch position for a displayed image and outputs touch position information to the processor 11.

The scanner 16 reads a code symbol such as a barcode or a two-dimensional data code attached to a commodity. A code symbol specific to the commodity is code attached to the commodity. The scanner 16 outputs data of the read code symbol to the processor 11. The scanner 16 may be a type of scanner that reads the code symbol by scanning with a laser beam, or may be a type of scanner that reads the code symbol from an image captured by an image-capturing device.

The reader 17 reads data recorded on the recording medium and outputs the read data to the processor 11. The reader 17 is a magnetic card reader when the recording medium is a magnetic card, and is an integrated card (IC) card reader when the recording medium is a contact IC card. In the case of a recording medium using radio frequency identification (RFID) such as a non-contact IC card or a smartphone, an RFID reader is used as the reader 17.

The camera 18 is provided in the cart C so that a shopping basket placed in the basket receiving part of the cart C can be photographed. The camera 18 is for monitoring that a customer who is a user of the cart C puts a purchased commodity into or takes out the purchased commodity from the shopping basket.

The camera controller 19 controls turning-on and turning-off of the camera 18. The camera controller 19 has a function of capturing and analyzing the image captured by the camera 18 in real time to detect a commodity put into the shopping basket or a commodity taken out from the shopping basket.

In the cart terminal 10 including the circuit components as described above, the processor 11, the main memory 12, the auxiliary storage device 13, the wireless unit 14, and the touch panel 15 are configured by a tablet terminal TM. The cart terminal 10 is configured by electrically connecting the scanner 16, the reader 17, the camera 18, and the camera controller 19 to the tablet terminal TM. The scanner 16, the camera 18, and the camera controller 19 may also be provided in the tablet terminal TM.

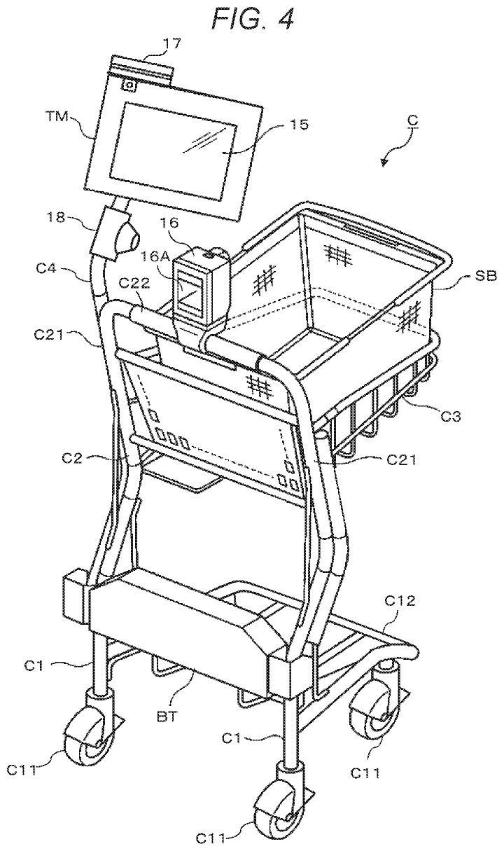

FIG. 4 is a perspective view illustrating an example of the cart C provided with the cart terminal 10. The cart C includes a caster part C1 for movement, a handle frame part C2, and a basket receiving part C3. The caster part C1 includes four wheels C11 for smoothly moving on the floor surface. The caster part C1 is provided with a receiving part C12 for placing a large luggage that does not fit into a shopping basket SB. The handle frame portion C2 includes a pair of vertical frames C21 and C21 erected on the rear wheel side of the caster part C1, and a handle bar C22 connecting the upper ends of the vertical frames C21 and C21. The basket receiving part C3 is located forward from a middle portion of the handle frame part C2. The cart C can place the shopping basket SB provided in the store on the basket receiving part C3.

The shopping basket SB functions as a storing body that stores the commodity. The storing body is not limited to the shopping basket SB. For example, the cart C may be used without placing the shopping basket SB on the basket receiving part C3. In this case, the basket receiving part C3 becomes a storing body.

The scanner 16 is in the middle portion of the handle bar C22. The scanner 16 is attached to the handle bar C22 so that a reading window 16A is positioned on the front side. The front side is the side where the customer who pushes the cart C with the handle bar C22 stands.

A pole C4 is attached to one vertical frame C21. The pole C4 includes a tip positioned above the handle bar C22. The tablet terminal TM is attached to the tip of the pole C4 with a screen of the touch panel 15 on the front side. The reader 17 is attached to the frame of the tablet terminal TM so that a card slit is positioned on the front side. In FIG. 4, the reader 17 is a magnetic card reader. The camera 18 is attached to the middle portion of the pole C4 so that the entire shopping basket SB placed in the basket receiving part C3 is photographed from above. The camera 18 is an example of an image-capturing unit.

A battery BT is attached across the vertical frames C21 and C21 on the lower end side of the handle frame portion C2. The battery BT is a driving power source for the tablet terminal TM, the scanner 16, the reader 17, the camera 18, and the camera controller 19.

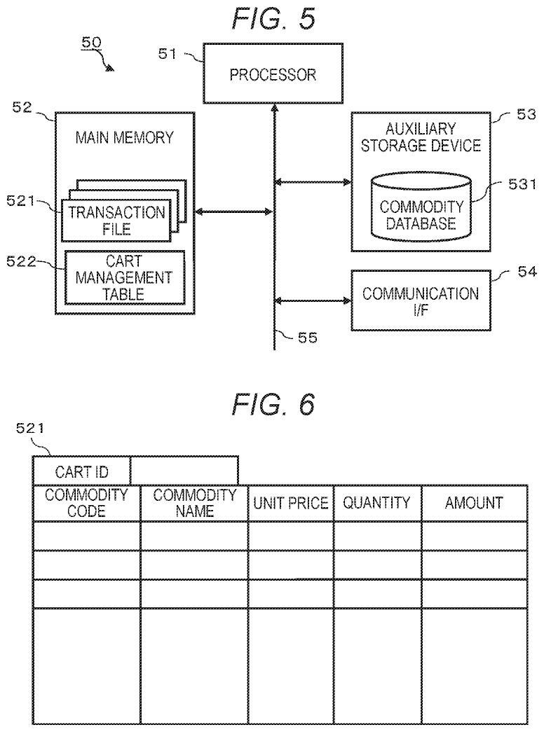

FIG. 5 is a block diagram illustrating a main circuit configuration of the server 50. The server 50 includes a processor 51, a main memory 52, an auxiliary storage device 53, a communication interface 54, and a system transmission path 55. The system transmission path 55 includes an address bus, a data bus, a control signal line, and the like. In the server 50, the processor 51, the main memory 52, the auxiliary storage device 53, and the communication interface 54 are connected to the system transmission path 55. In the server 50, a computer is configured by the processor 51, the main memory 52, the auxiliary storage device 53, and the system transmission path 55 connecting these components.

The processor 51 corresponds to the central part of the computer. The processor 51 controls each unit to implement various functions as the server 50 according to an operating system or an application program. The processor 51 is, for example, a CPU.

The main memory 52 corresponds to a main storage portion of the computer. The main memory 52 includes a nonvolatile memory area and a volatile memory area. The main memory 52 stores the operating system or the application program in the nonvolatile memory area. The main memory 52 may store data necessary for the processor 51 to execute a process for controlling each unit in the nonvolatile or the volatile memory area. The main memory 52 uses the volatile memory area as a work area in which data is appropriately rewritten by the processor 51. The nonvolatile memory area is, for example, a ROM. The volatile memory area is, for example, a RAM.

The auxiliary storage device 53 corresponds to an auxiliary storage portion of the computer. For example, an EEPROM, HDD, or SSD can be the auxiliary storage device 53. The auxiliary storage device 53 stores data used when the processor 51 performs various processes, data generated by the process in the processor 51, and the like. The auxiliary storage device 53 may store the application program described above.

The application program stored in the main memory 52 or the auxiliary storage device 53 includes a control program described regarding information processing executed by the server 50. A method for installing the control program in the main memory 52 or the auxiliary storage device 53 is not particularly limited. The control program can be installed in the main memory 52 or the auxiliary storage device 53 by being recorded on a removable recording medium, or distributed by communication via a network. The recording medium may be in any form as long as it can store a program and can be read by the apparatus, such as a CD-ROM or a memory card.

The communication interface 54 is connected to the network 60. The communication interface 54 performs data communication with other devices connected via the network 60 according to a communication protocol under the control of the processor 51.

The server 50 having such a configuration stores a commodity database 531 in the auxiliary storage device 53. The commodity database 531 is an area for storing a commodity record generated for each commodity. The commodity record includes data items such as a commodity code, a price, and a commodity name. The commodity code is a unique code set for each commodity in order to specify the commodity. The code symbol attached to the commodity includes at least the commodity code as information.

The server 50 uses a part of the volatile memory area of the main memory 52 as an area of a transaction file 521 and an area of a cart management table 522. In the area of the transaction file 521, the transaction file 521 is generated for each customer M1 who is shopping using the cart C.

FIG. 6 is a schematic diagram illustrating a principal data structure of the transaction file 521. As illustrated in FIG. 6, the transaction file 521 is a data file including an area for storing the cart ID and a plurality of pieces of commodity sales data. The commodity sales data is data including a commodity code, a commodity name, a unit price, a quantity, and an amount of money of commodity registered as a purchase target.

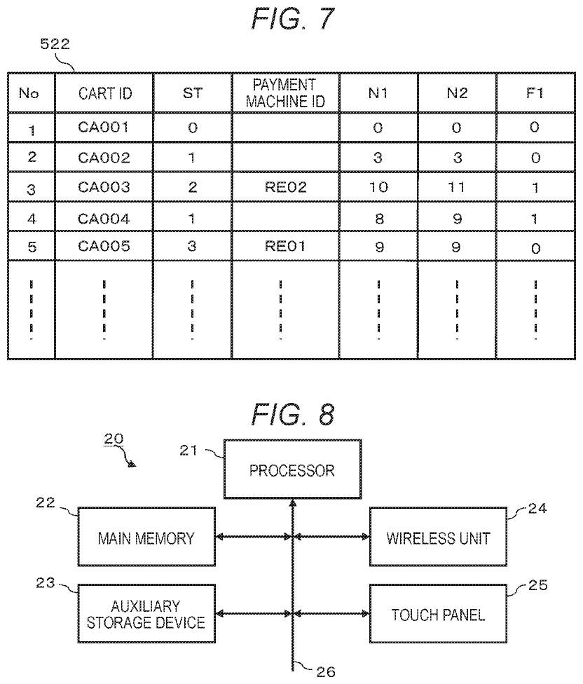

FIG. 7 is a schematic diagram illustrating a principal data structure of the cart management table 522. As illustrated in FIG. 7, the cart management table 522 has an area for storing a cart ID, a status ST, a payment machine ID, a first counter N1, a second counter N2, and a warning flag F1 in correlation with a series of table numbers 1, 2, 3, 4, 5, . . . . The cart ID of each cart terminal 10 is set in the cart ID area.

The status ST indicates a state of the cart terminal 10 specified by the cart ID. As described above, the cart terminal 10 has four states of waiting, under registration, waiting for payment, and under payment. In this embodiment, the status ST indicating waiting is set to “0”, the status ST indicating under-registration is set to “1”, the status ST indicating waiting-for-payment is set to “2”, and the status ST indicating under-payment is set to “3”.

The payment machine ID is a unique code set for each payment machine 40 in order to individually identify the plurality of payment machines 40. The first counter N1 is for counting the number of commodities registered in the cart terminal 10 specified by the cart ID. The second counter N2 is for counting the number of commodities put into the shopping basket SB of the cart C provided with the same cart terminal 10. The warning flag F1 is 1-bit data which is reset to “0” when the first counter N1 and the second counter N2 coincide with each other, but is set to “1” when the first and the second counters N1 and N2 do not coincide with each other.

FIG. 8 is a block diagram illustrating a main circuit configuration of the monitoring terminal 20. The monitoring terminal 20 includes a processor 21, a main memory 22, an auxiliary storage device 23, a wireless unit 24 (a wireless transmitter), a touch panel 25, and a system transmission path 26. The system transmission path 26 includes an address bus, a data bus, a control signal line, and the like. The monitoring terminal 20 connects the processor 21, the main memory 22, the auxiliary storage device 23, the wireless unit 24, and the touch panel 25 to the system transmission path 26 directly or via a signal input and output circuit. In the monitoring terminal 20, a computer is configured by the processor 21, the main memory 22, the auxiliary storage device 23, and the system transmission path 26 connecting these components.

The processor 21 corresponds to a central part of the computer. The processor 21 controls each unit to implement various functions as the monitoring terminal 20 according to an operating system and an application program. The processor 21 is, for example, a CPU.

The main memory 22 corresponds to a main memory portion of the computer. The main memory 22 includes a nonvolatile memory area and a volatile memory area. The main memory 22 stores the operating system and application program in the nonvolatile memory area. The main memory 22 stores data necessary for the processor to execute a process for controlling each unit in the volatile memory area. The data may be stored in the non-volatile memory area. The main memory 22 uses the volatile memory area as a work area where data is appropriately rewritten by the processor. For example, the nonvolatile memory area is a ROM. The volatile memory area is a RAM.

The auxiliary storage device 23 corresponds to an auxiliary storage portion of the computer. For example, an EEPROM, HDD, SSD or the like is used as the auxiliary storage device 23. The auxiliary storage device 23 stores data used when the processor 21 performs various processes and data generated by the process in the processor 21. The auxiliary storage device 23 may store the application program.

The application program stored in the main memory 22 or the auxiliary storage device 23 includes a control program described regarding information processing executed by the monitoring terminal 20. A method for installing the control program in the main memory 22 or the auxiliary storage device 23 is not particularly limited. The control program can be installed in the main memory 22 or the auxiliary storage device 23 by being recorded on a removable recording medium, or distributed by communication via a network. The recording medium may be in any form as long as it can store a program and can be read by the apparatus, such as a CD-ROM or a memory card.

The wireless unit 24 performs data transmission or reception with the access point 30 wirelessly according to a wireless communication protocol.

The touch panel 25 is a device including both an input device and a display device of the monitoring terminal 20. The monitoring terminal 20 is equipped with a browser for displaying an image on the touch panel 25 based on the image data generated by the server 50.

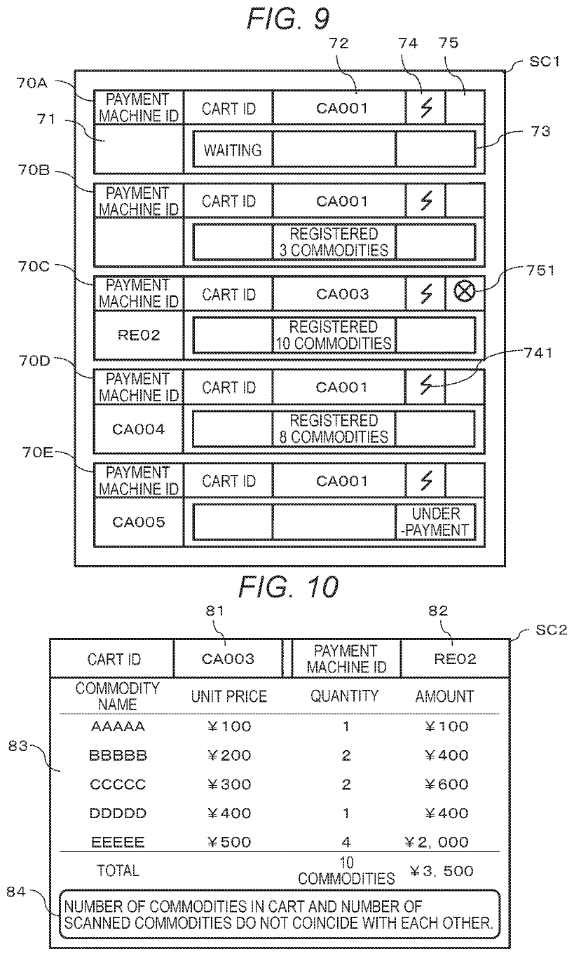

FIG. 9 and FIG. 10 are schematic diagrams illustrating an example of an image displayed on the touch panel 25. Specifically, FIG. 9 is an example of a cart terminal monitoring image SC1. In the cart terminal monitoring image SC1, tags 70 (70A, 70B, 70C, 70D, 70E, etc.) generated for each cart terminal 10 are displayed. In FIG. 9, the cart terminal monitoring image SC1 in which five tags 70A, 70B, 70C, 70D, and 70E are displayed in a row is illustrated, but the number of tags 70 displayed in the cart terminal monitoring image SC1 is not limited to five. A plurality of tags 70 may be displayed in a matrix.

The tag 70 includes an area 71 for displaying a payment machine ID, an area 72 where a cart ID is displayed, an area 73 where status ST information is displayed, an area 74 where a communication icon 741 is displayed, and an area 75 where a warning icon 751 is displayed. In the area 71, the payment machine ID of the payment machine 40 for which a customer who made a purchase using the cart C provided with the cart terminal 10 specified by the cart ID displayed in the area 72 performs payment is displayed. Hereinafter, the cart terminal 10 specified by the cart ID displayed in the area 72 is referred to as the corresponding cart terminal 10. In the area 73, different information is displayed depending on the status ST of the corresponding cart terminal 10. For example, when the status ST is “0”, that is, when it is waiting, “waiting” is displayed. When the status ST is “1” or “2”, that is, when it is under-registration or waiting-for-payment, “registered n commodities” is displayed. “n” of “registered n commodities” is the total number of commodities registered in the corresponding cart terminal 10. When the status ST is “3”, that is, when it is under-payment, “under payment” is displayed. In the area 74, the communication icon 741 is displayed when the corresponding cart terminal 10 is in communication with the server 50. In the area 75, the warning icon 751 is displayed when the warning flag F1 for the corresponding cart terminal 10 becomes “1”.

FIG. 10 is an example of a registered commodity list image SC2. When any one of the tags 70 displayed in the cart terminal monitoring image SC1 is selected, a list of commodities registered in the cart terminal 10 having the cart ID assigned to the tag 70 is displayed on the touch panel 25 as the registered commodity list image SC2. The registered commodity list image SC2 includes an area 81 where the cart ID is displayed, an area 82 where the payment machine ID is displayed, an area 83 where a registered commodity list is displayed, and an area 84 where the warning message is displayed. In the area 83, the registered commodity list generated based on the commodity sales data stored in the transaction file 521 specified by the cart ID displayed in the area 81 is displayed. Specifically, a list of commodity names, unit prices, quantities, and amount of money of commodity sales data, and total quantities and total amount of money is displayed. In the area 84, a warning message indicating that the warning flag F1 is “1” is displayed. As described above, the warning flag F1 becomes “1” when the first counter N1 and the second counter N2 do not coincide with each other. Accordingly, as the warning message, for example, “The number of commodities in the cart and the number of scanned commodities do not coincide with each other.” can be considered. Needless to say, an example of a warning message is not limited thereto.

As the monitoring terminal 20 having the configuration described above, for example, a computer device such as a tablet terminal, a notebook personal computer, or a desktop personal computer can be applied as it is.

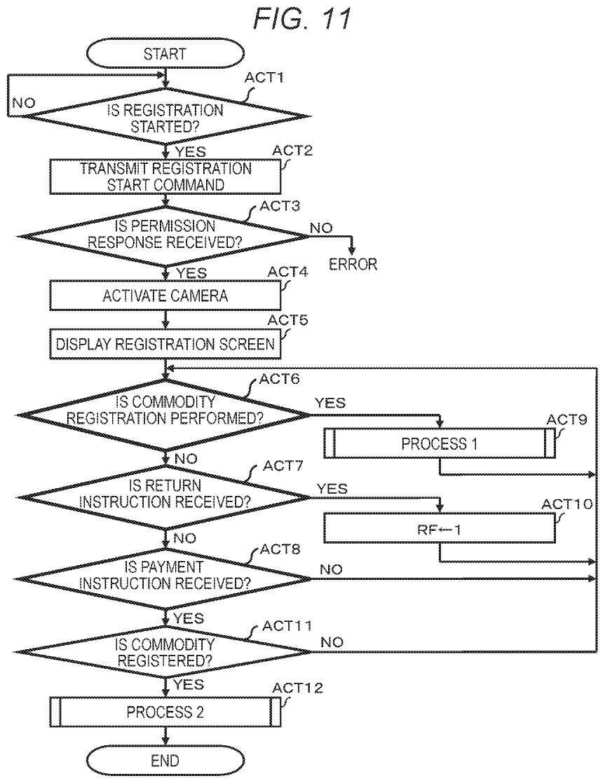

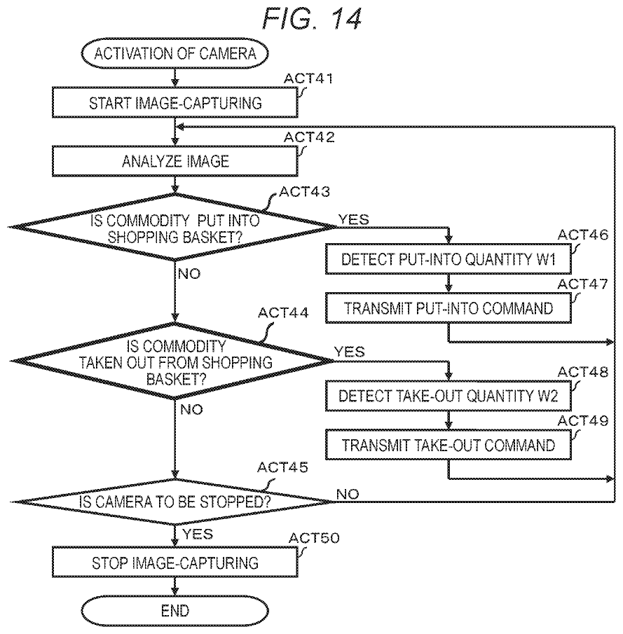

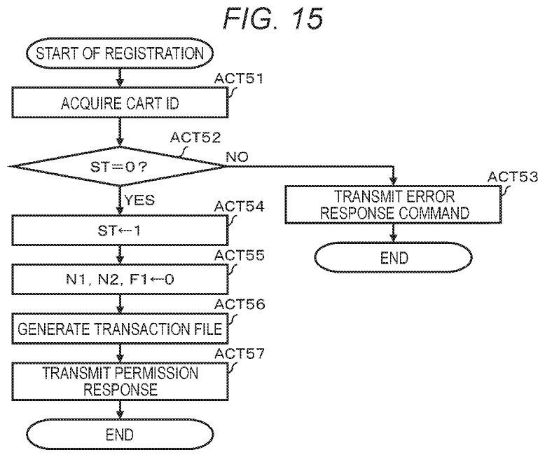

Next, the operation of the self-registration system according to this embodiment will be described with reference to the flowcharts of FIGS. 11 to 23. FIGS. 11 to 13 are flowcharts illustrating principal information processing procedures executed by the processor 11 of the cart terminal 10 according to the control program. FIG. 14 is a flowchart illustrating the principal information processing procedure executed by the camera controller 19 of the cart terminal 10 according to the control program. FIGS. 15 to 23 are flowcharts illustrating the principal information processing procedures executed by the processor 51 of the server 50 according to the control program. The procedures and the content of the operations described below are examples. As long as similar results can be obtained, the procedures and contents are not particularly limited.

First, in a retail store where a self-registration system is introduced, an unused cart C is placed in a cart yard. The cart terminal 10 provided in the unused cart C is in a waiting. That is, in the cart management table 522, the status ST correlated with the cart ID of the cart terminal 10 is “0”.

Now, a customer M1 who visits the store takes out the cart C from the cart yard. The customer M1 instructs the start of registration by touching the screen of the touch panel 15, for example. A registration start instruction operation is not limited to a screen touch operation of the touch panel 15. For example, the registration start may be instructed by causing the reader 17 to read the data of the membership card possessed by the customer M1.

As illustrated in FIG. 11, the processor 11 of the cart terminal 10 which is in the waiting state waits for an instruction to start registration as ACT 1. When the instruction to start registration is received, the processor 11 determines that the determination result in ACT 1 is YES, and proceeds to ACT 2. The processor 11 controls the wireless unit 14 to transmit a registration start command to the server 50 as ACT 2. With this control, the registration start command is wirelessly transmitted from the wireless unit 14. The registration start command includes the cart ID stored in the main memory 12. The registration start command is received by the access point 30 and sent to the server 50 via the network 60.

The processor 51 of the server 50 that receives the registration start command via the communication interface 54 starts information processing of the procedure illustrated in the flowchart of FIG. 15. The processor 51 acquires the cart ID from the registration start command as ACT 51. Then, the processor 51 retrieves the cart management table 522 as ACT 52 and confirms that the status ST correlated with the cart ID is “0” indicating waiting. Incidentally, when the status ST is other than “0”, it is an error that the registration start command is transmitted from the cart terminal 10 which is not in the waiting state. In this case, the processor 51 determines that the determination result in ACT 52 is NO, and proceeds to ACT 53. The processor 51 controls the communication interface 54 to transmit an error response command to the cart terminal 10 which is a registration start command transmission source, as ACT 53. Thus, the processor 51 ends the registration start command reception process.

The error response command is transmitted from the communication interface 54 to the access point 30 via the network 60, further wirelessly transmitted from the access point 30, and received by the cart terminal 10 which is the registration start command transmission source.

When the processor 51 confirms that the status is “0”, the processor 51 determines that the determination result in ACT 52 is YES, and proceeds to ACT 54. The processor 51 changes its status ST to “1” indicating under-registration, as ACT 54. The processor 51 initializes all of the first counter N1, the second counter N2, and the warning flag F1 correlated with the cart ID of the cart management table 522 to “0”, as ACT 55. The processor 51 generates the transaction file 521 in which the corresponding cart ID is set in a predetermined area of the main memory 52, as ACT 56. The processor 51 controls the communication interface 54 to transmit a permission response command to the cart terminal 10 which is the registration start command transmission source, as ACT 57. Thus, the processor 51 ends the registration start command reception process.

The permission response command is transmitted from the communication interface 54 to the access point 30 via the network 60, further wirelessly transmitted from the access point 30, and received by the cart terminal 10 which is the registration start command transmission source.

As such, when the customer M1 touches the touch panel 15 of the cart terminal 10 which is in the waiting state to instruct start of registration, in the server 50, the status correlated with the cart ID of the cart terminal 10 and stored in the cart management table 522 is changed from “0” to “1”. The transaction file 521 in which the corresponding cart ID is set is generated in the main memory 52. Then, the permission response command is transmitted to the cart terminal 10 which is the registration start command transmission source.

Description will be made by referring back to FIG. 11. The processor 11 of the cart terminal 10 that transmits the registration start command is waiting for the permission response command, as ACT 3 in FIG. 11. Here, when an error response command is received instead of the permission response command, the processor 11 determines that the determination result in ACT 3 is NO, and executes an error process. As the error process, for example, a process of displaying a message prohibiting use of the cart terminal 10 on the touch panel 25 can be considered.

When the permission response command is received, the processor 11 determines that the determination result in ACT 3 is YES, and proceeds to ACT 4. The processor 11 instructs the camera controller 19 to activate the camera 18, as ACT 4. The operation of the camera controller 19 that receives an activation command will be described later.

The processor 11 displays a registration screen on the touch panel 25, as ACT 5. The registration screen is a screen for displaying the commodity name, unit price, and the like of the commodity for which the commodity sales data is registered. On a part of the registration screen, an image of a payment button for receiving a payment instruction and an image of a return button for receiving a return instruction are displayed. Operation guidance for the customer M1 may be displayed on a part of the registration screen. As the operation guidance, for example, “Please place the barcode of the commodity on the reading window 16A of the scanner 16 before putting the commodity to be purchased in the shopping basket SB.” can be considered.

When the processes of ACT 4 and ACT 5 are completed, the processor 11 confirms whether or not the commodity registration is performed, as ACT 6. When it is confirmed that the commodity registration is not performed, the processor 11 determines that the confirmation result in ACT 6 is NO, and proceeds to ACT 7. The processor 11 confirms whether or not a return instruction is received, as ACT 7. When it is confirmed that the return instruction is not received, the processor 11 determines that the confirmation result in ACT 7 is NO, and proceeds to ACT 8. The processor 11 confirms whether or not a payment instruction is received, as ACT 8. When it is confirmed that the payment instruction is not received, the processor 11 determines that the confirmation result in ACT 8 is NO, and proceeds to ACT 6. Here, the processor 11 waits for the commodity registration to be performed, the reception of the return instruction, or the reception of a payment instruction by the processes of ACT 6 to ACT 8.

When the customer M1 who is shopping using the cart C finds a commodity to be purchased at the sales floor P, he/she causes a code symbol such as a barcode attached to the commodity to be read by being placed on the reading window 16A of the scanner 16, and then puts the commodity into the shopping basket SB. When canceling the purchase of the commodity put in the shopping basket SB, the customer M1 touches the return button and takes out the commodity from the shopping basket SB. The customer M1 reads the code symbol attached to the commodity by being placed on the reading window 16A of the scanner 16 and then returns the commodity to a shelf or the like. The customer M1 who completes shopping at the sales floor P touches the payment button and issues a payment instruction.

When the code symbol data is read through the scanner 16 in the waiting state of ACT 6 to ACT 8, the processor 11 detects that the commodity registration is performed. The processor 11 determines that the determination result in ACT 6 is YES, and proceeds to ACT 9. The processor 11 executes “Process 1”, as ACT 9. The procedure of “Process 1” and its contents will be described later. When the processor 11 completes executing “Process 1”, the process returns to the waiting state of ACT 6 to ACT 8.

When the return button is touched in the waiting state of ACT 6 to ACT 8, the processor 11 detects that a return instruction is performed. The processor 11 determines that the determination result in ACT 7 is YES, and proceeds to ACT 10. The processor 11 sets a return flag RF to “1”, as ACT 10. The return flag RF is stored in the volatile area of the main memory 12. Thereafter, the processor 11 returns to the waiting state of ACT 6 to ACT 8.

When the payment button is touched in the waiting state of ACT 6 to ACT 8, the processor 11 detects that the payment instruction is performed. The processor 11 determines that the determination result in ACT 8 is YES, and proceeds to ACT 11. The processor 11 confirms whether or not the commodity is registered, as ACT 11. The processor 11 recognizes that the commodity is registered when the process of “Process 1” of ACT 9 is executed even once. When the commodity is not registered, the processor 11 determines that the determination result in ACT 11 is NO, and returns to the waiting state of ACT 6 to ACT 8. When the commodity is registered, the processor 11 determines that the determination result in ACT 11 is YES, and proceeds to ACT 12. The processor 11 executes “Process 2”, as ACT 12. The procedure of “Process 2” and its contents will be described later. When the processor 11 completes executing “Process 2”, the processor 11 ends the process according to the registration start instruction.

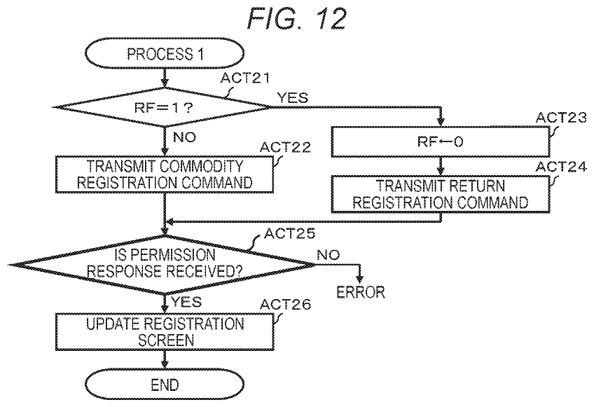

FIG. 12 is a flowchart illustrating the procedure of “Process 1”. In ACT 6 in FIG. 11, when it is detected that the commodity registration is performed, the processor 11 starts “Process 1”. First, the processor 11 confirms whether or not the return flag RF is set to “1”, as ACT 21. When it is confirmed that the return flag RF is not set to “1”, the processor 11 determines that the determination result in ACT 21 is NO, and proceeds to ACT 22. The processor 11 controls the wireless unit 14 to transmit a commodity registration command to the server 50, as ACT 22. With this control, the commodity registration command is wirelessly transmitted from the wireless unit 14. The cart ID and scanning data are included in the commodity registration command. The scanning data is data obtained from code symbols read by the scanner 16. The commodity code is included in the data. The commodity registration command is received by the access point 30 and sent to the server 50 via the network 60.

On the other hand, when it is confirmed that the return flag RF is set to “1”, the processor 11 determines that the determination result in ACT 21 is YES, and proceeds to ACT 23. The processor 11 resets the return flag RF to “0”, as ACT 23. The processor 11 controls the wireless unit 14 to transmit a return registration command to the server 50, as ACT 24. With this control, the return registration command is wirelessly transmitted from the wireless unit 14. The return registration command includes the cart ID and the scanning data. The return registration command is received by the access point 30 and sent to the server 50 via the network 60.

As such, when the customer M1 reads a code symbol such as a barcode attached to the commodity by placing the code symbol on the reading window 16A of the scanner 16, the commodity registration command is transmitted from the cart terminal 10 to the server 50. When the customer M1 touches the return button and reads the code symbol attached to the commodity by placing the code symbol on the reading window 16A of the scanner 16, the return registration command is transmitted from the cart terminal 10 to the server 50. The commodity code of the commodity specified by the code symbol read by the scanner 16 is included in the commodity registration command and the return commodity registration command. Here, the computer including the processor 11 of the cart terminal 10 as a main component cooperates with the scanner 16 to constitute a specifying unit configured to specify the commodity to be purchased.

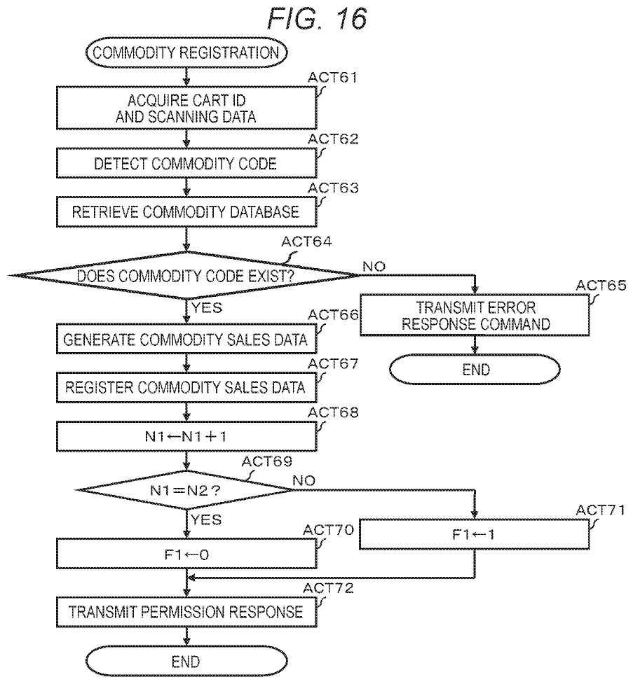

The processor 51 of the server 50 that receives the commodity registration command via the communication interface 54 starts information processing according to a procedure illustrated in the flowchart of FIG. 16. The processor 51 acquires the cart ID and the scanning data from the commodity registration command, as ACT 61. The processor 51 detects the commodity code from the scanning data, as ACT 62.

The processor 51 retrieves the commodity database 531 with the commodity code, as ACT 63. The processor 51 confirms whether or not a commodity record including the commodity code exists in the commodity database 531, as ACT 64. When it is confirmed that the commodity record including the commodity code does not exist in the commodity database 531, it is an error in which the commodity code which is not set in the commodity database 531 is read. In this case, the processor 51 determines that the determination result in ACT 64 is NO, and proceeds to ACT 65. The processor 51 controls the communication interface 54 to transmit an error response command to the cart terminal 10 which is a commodity registration command transmission source, as ACT 65. Thus, the processor 51 ends the commodity registration command reception process.

The error response command is wirelessly transmitted from the access point 30 in the same manner as described above, and is received by the cart terminal 10 which is a registration start command transmission source.

When it is confirmed that the commodity record including the commodity code exists in the commodity database 531, the processor 51 determines that the determination result in ACT 64 is YES, and proceeds to ACT 66. The processor 51 generates commodity sales data, as ACT 66. That is, the processor 51 generates commodity sales data from the commodity code detected in ACT 62, the product name and unit price, quantity, and amount of money of the commodity record including the commodity code. Incidentally, the quantity is “1”. The amount of money is a value obtained by multiplying the unit price by the quantity.

When the process of ACT 66 is completed, the processor 51 registers the commodity sales data in the transaction file, as ACT 67. That is, the processor 51 selects the transaction file 521 in which the cart ID acquired in ACT 61 is set. Then, the processor 51 registers the commodity sales data in the transaction file 521.

When the process of ACT 67 is completed, the processor 51 counts up the first counter N1 stored in the cart management table 522 in correlation with the cart ID by “1”, as ACT 68. The processor 51 compares the first counter N1 and the second counter N2 that are stored in the cart management table 522 in correlation with the cart ID, as ACT 69. Here, when it is determined that the first counter N1 and the second counter N2 coincide with each other, the processor 51 determines that the determination result in ACT 69 is YES, and proceeds to ACT 70. The processor 51 sets the warning flag F1 stored in the cart management table 522 in correlation with the cart ID to “0”, as ACT 70.

When it is determined that the first counter N1 and the second counter N2 do not coincide with each other, the processor 51 determines that the determination result in ACT 69 is NO, and proceeds to ACT 71. The processor 51 sets the warning flag F1 stored in the cart management table 522 in correlation with the corresponding cart ID to “1”, as ACT 71.

When the process of ACT 70 or ACT 71 is completed, the processor 51 controls the communication interface 54 to transmit a permission response command to the cart terminal 10 which is the commodity registration command transmission source, as ACT 72. Thus, the processor 51 ends the commodity registration command reception process.

The permission response command is transmitted from the communication interface 54 to the access point 30 via the network 60, further wirelessly transmitted from the access point 30, and received by the cart terminal 10 which is the registration start command transmission source. The commodity sales data generated in ACT 66 is included in the permission response command.

As such, when the customer M1 reads the code symbol of the commodity to be purchased by the scanner 16, the commodity sales data of the commodity is registered in the transaction file 521 in which the cart ID of the cart terminal 10 operated by the customer M1 is set. The first counter N1 correlated with the corresponding cart ID in the cart management table 522 is counted up by “1”. In this case, when the first counter N1 does not coincided with the second counter N2 correlated with the corresponding cart ID, the warning flag F1 becomes “1”. When the first counter N1 coincides with the second counter N2, the warning flag F1 becomes “0”.

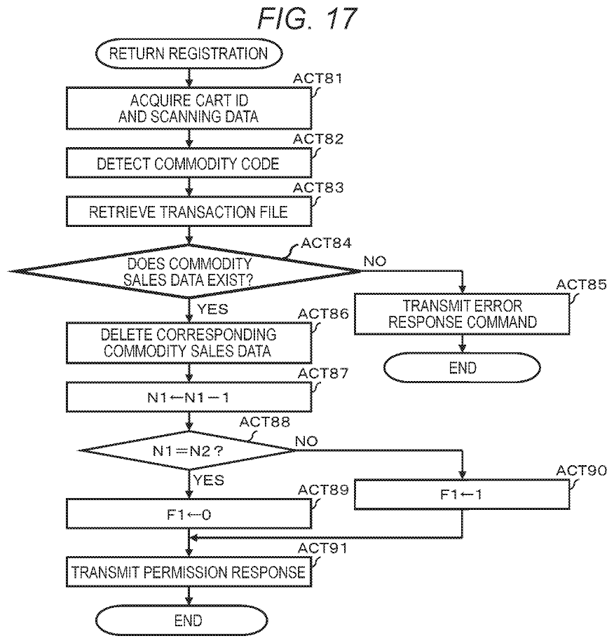

The processor 51 of the server 50 that receives the return registration command via the communication interface 54 starts information processing of the procedure illustrated in the flowchart of FIG. 17. The processor 51 acquires the cart ID and the scanning data from the return registration command, as ACT 81. The processor 51 detects the commodity code from the scanning data, as ACT 82.

The processor 51 retrieves the transaction file 521 in which the cart ID is set, as ACT 83. The processor 51 confirms whether or not the commodity sales data of the commodity code detected in ACT 82 exists in the transaction file 521, as ACT 84. When it is confirmed that the corresponding commodity sales data does not exist, it is an error instructed to return an unregistered commodity. In this case, the processor 51 determines that the determination result in ACT 84 is NO, and proceeds to ACT 85. The processor 51 controls the communication interface 54 to transmit an error response command to the cart terminal 10 which is a return registration command transmission source, as ACT 85. Thus, the processor 51 ends the return registration command reception process.

The error response command is wirelessly transmitted from the access point 30 similarly as described above, and is received by the cart terminal 10 which is the registration start command transmission source.

When it is confirmed that the corresponding commodity sales data exists in the transaction file 521, the processor 51 determines that the determination result in ACT 84 is YES, and proceeds to ACT 86. The processor 51 deletes the corresponding commodity sales data from the transaction file 521, as ACT 86. When a plurality of pieces of corresponding commodity sales data exist in the transaction file 521, the processor 51 selects any one commodity sales data and deletes the commodity sales data from the transaction file 521.

When the process of ACT 86 is completed, the processor 51 counts down the first counter N1 stored in the cart management table 522 in correlation with the cart ID acquired in ACT 81 by “1”, as ACT 87. The processor 51 compares the first counter N1 and the second counter N2 that are stored in the cart management table 522 in correlation with the cart ID, as ACT 87. Here, when it is determined that the first counter N1 and the second counter N2 coincide with each other, the processor 51 determines that the determination result in ACT 87 is YES, and proceeds to ACT 88. The processor 51 sets the warning flag F1 stored in the cart management table 522 in correlation with the cart ID to “0”, as ACT 88.

When it is determined that the first counter N1 and the second counter N2 do not coincide with each other, the processor 51 determines that the determination result in ACT 87 is NO, and proceeds to ACT 89. The processor 51 sets the warning flag F1 stored in the cart management table 522 in correlation with the cart ID to “1”, as ACT 89.

When the process of ACT 88 or ACT 89 is completed, the processor 51 controls the communication interface 54 to transmit the permission response command to the cart terminal 10 which is the return registration command transmission source, as ACT 90. Thus, the processor 51 ends the return registration command reception process.

The permission response command is transmitted from the communication interface 54 to the access point 30 via the network 60, further wirelessly transmitted from the access point 30, and received by the cart terminal 10 which is the return registration command transmission source. The commodity sales data deleted from the transaction file 521 in ACT 85 is included in the permission response command.

As such, when the customer M1 touches the return button and causes the scanner 16 to read the code symbol of the commodity to be returned, the commodity sales data of the commodity is deleted from the transaction file 521 in which the cart ID of the cart terminal 10 operated by the customer is set. The first counter N1 correlated with the corresponding cart ID of the cart management table 522 is counted down by “1”. In this case, when the first counter N1 does not coincide with the second counter N2 correlated with the cart ID, the warning flag F1 becomes “1”. When the first counter N1 coincides with the second counter N2, the warning flag F1 becomes “0”.

Description will be made by referring back to FIG. 12. The processor 11 of the cart terminal 10 that controls transmission of the commodity registration command or the return registration command waits to receive a permission response command, as ACT 25. Here, when an error response command is received instead of the permission response command, the processor 11 determines that the determination result in ACT 25 is NO, and executes the error process. As the error process, for example, a process of displaying a message indicating a registration error or a return error on the touch panel 25 can be considered.

When the permission response command is received, the processor 11 determines that the determination result in ACT 25 is YES, and proceeds to ACT 26. The processor 11 updates the registration screen, as ACT 26. That is, when the commodity registration is performed, the processor 11 displays the commodity name, unit price, and the like of the commodity sales data included in the permission response command on the registration screen. When the return registration is performed, the processor 11 deletes the commodity name, unit price, and the like of the commodity sales data included in the permission response command from the registration screen.

Here, an operation of the camera controller 19 will be described with reference to the flowchart of FIG. 14. The camera controller 19 to which activation of the camera 18 is instructed from the processor 11 activates the camera 18 to start photographing, as ACT 41. The camera controller 19 analyzes an image captured by the camera 18, as ACT 42.

The camera controller 19 confirms whether or not action of the customer putting the commodity into the shopping basket SB is projected on the image, as ACT 43. When it is confirmed that the action is not projected on the image, the camera controller 19 determines that the determination result in ACT 43 is NO, and proceeds to ACT 44. The camera controller 19 confirms whether or not the action of the customer taking out the commodity from the shopping basket SB is projected on the image, as ACT 44. When the action is not projected on the image, the camera controller 19 determines that the determination result in ACT 44 is NO, and proceeds to ACT 45. The camera controller 19 confirms whether or not the stop of the camera 18 is commanded, as ACT 45. When it is confirmed that the stop of the camera 18 is not commanded, the camera controller 19 returns to ACT 42.

As such, until the camera controller 19 is commanded to stop the camera 18, the camera controller 19 analyzes the image captured by the camera 18 in real time and waits until action that the customer M1 puts the commodity into the shopping basket SB or action that the customer M1 takes out the commodity from the shopping basket SB is projected on the image.

When the camera controller 19 detects action of the customer M1 putting the commodity into the shopping basket SB by image analysis, the camera controller 19 determines that the determination result in ACT 43 is YES, and proceeds to ACT 46. The camera controller 19 detects a put-into quantity W1 of commodities from an image in which the action is detected, as ACT 46. Then, the camera controller 19 controls the wireless unit 14 to transmit a put-into command to the server 50, as ACT 47. With this control, the put-into command is wirelessly transmitted from the wireless unit 14. The put-into quantity W1 and the cart ID are included in the put-into command. The put-into command is received by the access point 30 and sent to the server 50 via the network 60.

When the camera controller 19 detects an action of the customer M1 taking out the commodity from the shopping basket SB by image analysis, the camera controller 19 determines that the determination result in ACT 44 is YES, and proceeds to ACT 48. The camera controller 19 detects a take-out quantity W2 of commodities from the image in which the action is detected, as ACT 48. Then, the camera controller 19 controls the wireless unit 14 to transmit a take-out command to the server 50, as ACT 49. With this control, the take-out command is wirelessly transmitted from the wireless unit 14. The take-out quantity W2 and the cart ID are included in the take-out command. The take-out command is received by the access point 30 and sent to the server 50 via the network 60.

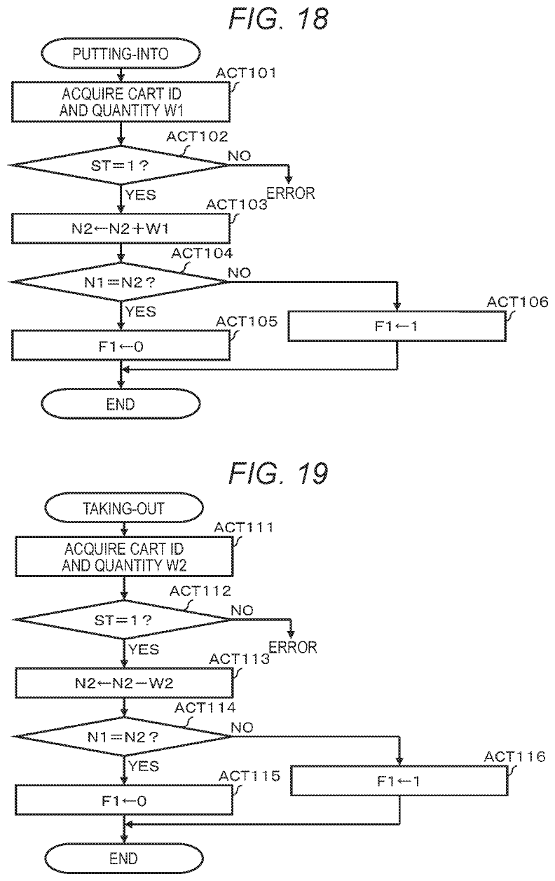

The processor 51 of the server 50 that receives the put-into command via the communication interface 54 starts an information processing procedure illustrated in a flowchart of FIG. 18. The processor 51 acquires the cart ID and the put-into quantity W1 from the put-into command, as ACT 101. Then, the processor 51 retrieves the cart management table 522 and confirms whether or not the status ST correlated with the cart ID is “1”, as ACT 102. When it is confirmed that the status ST is not “1”, the processor 51 determines that the determination result in ACT 102 is NO and regards that it is an error.

When it is confirmed that the status ST is “1”, the processor 51 counts up the second counter N2 stored in the cart management table 522 in correlation with the cart ID by the put-into quantity W1, as ACT 103. The processor 51 compares the first counter N1 and the second counter N2 that are stored in the cart management table 522 in correlation with the cart ID, as ACT 104. When it is determined that the first counter N1 coincides with the second counter N2, the processor 51 determines that the determination result in ACT 104 is YES, and proceeds to ACT 105. The processor 51 sets the warning flag F1 stored in the cart management table 522 in correlation with the cart ID to “0”, as ACT 105.

When it is determined that the first counter N1 and the second counter N2 do not coincide with each other, the processor 51 determines that the determination result in ACT 104 is NO, and proceeds to ACT 106. The processor 51 sets the warning flag F1 stored in the cart management table 522 in correlation with the cart ID to “1”, as ACT 106. Thus, the processor 51 ends the put-into command reception process.

As such, when the customer M1 puts the commodity into the shopping basket SB of the cart C, the put-into command is transmitted from the camera controller 19 of the camera 18 provided in the cart C to the server 50. The number of commodities put into the shopping basket SB by the customer M1, the so-called put-into quantity W1 is included in the put-into command. In the server 50, the second counter N2 correlated with the cart ID of the corresponding cart C in the cart management table 522 is counted up by the put-into quantity W1. In this time, when the second counter N2 does not coincide with the first counter N1 correlated with the cart ID, the warning flag F1 becomes “1”. When the second counter N2 coincides with the first counter N1, the warning flag F1 becomes “0”.

The processor 51 of the server 50 that receives the take-out command via the communication interface 54 starts information processing of a procedure illustrated in a flowchart of FIG. 19. The processor 51 acquires the cart ID and the take-out quantity W2 from the take-out command, as ACT 111. Then, the processor 51 retrieves the cart management table 522 and confirms whether or not the status ST correlated with the cart ID is “1”, as ACT 112. When it is confirmed that the status ST is not “1”, the processor 51 determines that the determination result in ACT 112 is NO, and regards that it is an error.

When it is confirmed that the status ST is “1”, the processor 51 takes out the second counter N2 stored in the cart management table 522 in correlation with the cart ID and counts down by the take-out quantity W2, as ACT 113. The processor 51 compares the first counter N1 and the second counter N2 that are stored in the cart management table 522 in correlation with the cart ID, as ACT 114. Here, when it is determined that the first counter N1 coincides with the second counter N2, the processor 51 determines that the determination result in ACT 114 is YES, and proceeds to ACT 115. The processor 51 sets the warning flag F1 stored in the cart management table 522 in correlation with the cart ID to “0”, as ACT 115.

When it is determined that the first counter N1 and the second counter N2 do not coincide with each other, the processor 51 determines that the determination result in ACT 114 is NO, and proceeds to ACT 116. The processor 51 sets the warning flag F1 stored in the cart management table 522 in correlation with the cart ID to “1”, as ACT 116. Thus, the processor 51 ends the take-out command reception process.

As such, when the customer M1 takes out the commodity from the shopping basket SB of the cart C, the take-out command is transmitted from the camera controller 19 of the camera 18 provided in the cart C to the server 50. The number of commodities taken out from the shopping basket SB by the customer M1, the so-called take-out quantity W2 is included in the take-out command. In the server 50, the second counter N2 correlated with the cart ID of the cart C in the cart management table 522 is counted down by the take-out quantity W2. In this case, when the second counter N2 does not coincide with the first counter N1 correlated with the cart ID, the warning flag F1 becomes “1”. When the second counter N2 coincides with the first counter N1, the warning flag F1 becomes “0”.

Description will be made by referring back to FIG. 14. The camera controller 19 stops the image-capturing operation of the camera 18 when the camera 18 is commanded to stop. Thus, the operation of the camera controller 19 is completed.

Here, the computer mainly including the processor 51 of the server 50 executes the processes of ACT 101 and ACT 103 of FIG. 18 and the processes of ACT 111 and ACT 113 of FIG. 19 in cooperation with the cart management table 522, thereby configuring the first acquisition unit. That is, the computer acquires the number of commodities stored in the storing body that stores the commodities to be purchased as the count value of the second counter N2.

The computer executes the process of ACT 68 in FIG. 16 and the process of ACT 87 in FIG. 17 in cooperation with the cart management table 522, thereby configuring the second acquisition unit. That is, the computer acquires the number of commodities specified by the specifying unit configured to specify the commodity to be purchased as the count value of the first counter N1.

Furthermore, the computer executes the processes of ACT 69 to ACT 71 of FIG. 16, the processes of ACT 88 to ACT 90 of FIG. 17, the processes of ACT 104 to ACT 106 of FIG. 18, and the processes of ACT 114 to ACT 116 of FIG. 19 in cooperation with the cart management table 522, thereby configuring a determination unit. That is, when the number of commodities acquired by the first acquisition unit does not coincide with the number of commodities acquired by the second acquisition unit, the computer determines to notify by setting the warning flag F1 to “1”. When the number of commodities acquired by the first acquisition unit coincides with the number of commodities acquired by the second acquisition unit, the computer determines not to notify by setting the warning flag F1 to “0”.

Since the server 50 has such a configuration, the following operation works in the self-registration system. That is, the customer M1 causes the scanner 16 to read the code symbol of the commodity to be purchased, and then puts the commodity into the shopping basket SB. In such a case, both the first counter N1 and the second counter N2 correlated with the cart ID of the cart terminal 10 used by the customer M1 are counted up by “1”. Accordingly, since the first counter N1 and the second counter N2 coincide with each other, the warning flag F1 becomes “0”. Therefore, notification is not performed.

The customer M1 touches the return button and takes out the commodity to be returned from the shopping basket SB and causes the scanner 16 to read the code symbol attached to the commodity, and then, returns the commodity to the shelf or the like. In such a case, both the first counter N1 and the second counter N2 correlated with the cart ID of the cart terminal 10 used by the customer M1 are counted down by “1”. Accordingly, since the first counter N1 and the second counter N2 coincide with each other, the warning flag F1 becomes “0”. Therefore, notification is not performed.

As such, while the customer M1 who uses the cart C correctly operates the cart terminal 10 provided in the cart C and registers the commodity to be purchased or the commodity to be returned, the first counter N1 and the second counter N2 correlated with the cart ID of the cart terminal 10 have the same value, and thus notification is not performed.

On the other hand, when the commodity code symbol is not read by the scanner 16 and the commodity is put into the shopping basket SB, only the second counter N2 is counted up. Accordingly, the first counter N1 and the second counter N2 do not coincide with each other, and the warning flag F1 becomes “1”. Therefore, notification is performed.

Even when the code symbol of the commodity is read by the scanner 16, if two or more commodities are put into the shopping basket SB at the same time, the first counter N1 and the second counter N2 again do not coincide with each other. Accordingly, the warning flag F1 becomes “1”, and thus notification is performed.

When the commodity is taken out from the shopping basket SB without the code symbol of the commodity being read by the scanner 16, only the second counter N2 is counted down. Accordingly, the first counter N1 and the second counter N2 do not coincide with each other, and the warning flag F1 becomes “1”. Therefore, notification is performed.

There may be a case where the customer M1 takes out the commodity from the shopping basket SB without touching the return button and causes the scanner 16 to read the code symbol attached to the commodity. In this case, since the first counter N1 is counted up and the second counter N2 is counted down, the first counter N1 and the second counter N2 also do not coincide with each other. Accordingly, the warning flag F1 becomes “1”. Therefore, notification is performed.

In addition, when the first counter N1 and the second counter N2 do not coincide with each other due to an illegal operation or an incorrect operation of the customer M1, the warning flag F1 becomes “1” and notification is performed.

The notification is performed via the cart terminal monitoring image SC1 displayed on the touch panel 25 of the monitoring terminal 20. The notification is also performed via the cart terminal 10 used by the customer who issues the payment instruction.

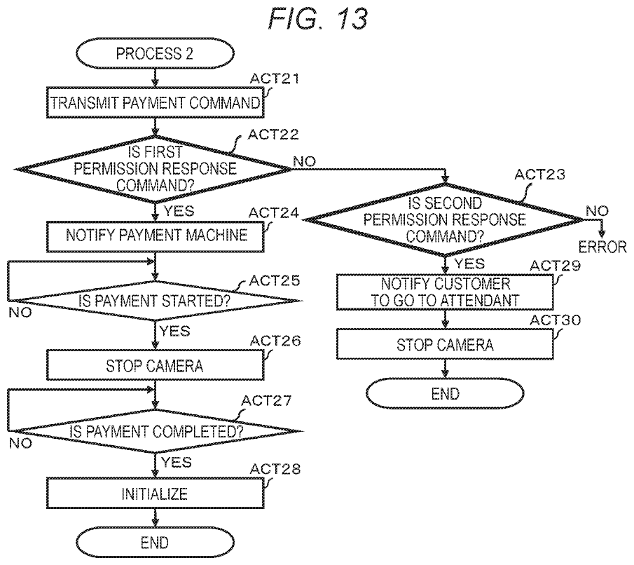

FIG. 13 is a flowchart illustrating a procedure of “Process 2”. When it is detected in ACT 10 of FIG. 11 that a payment instruction is issued and it is confirmed in ACT 11 that the commodity is registered, the processor 11 starts “Process 2”. The processor 11 controls the wireless unit 14 to transmit a payment command to the server 50, as ACT 21. With this control, the payment command is wirelessly transmitted from the wireless unit 14. A cart ID is included in the payment command. The payment command is received by the access point 30 and sent to the server 50 via the network 60.

As such, when the customer M1 who completes shopping at the sales floor P touches the payment button, the payment command is transmitted from the cart terminal 10 to the server 50.

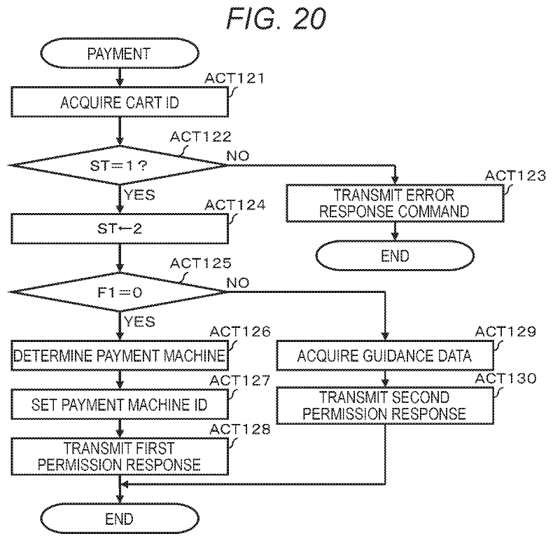

The processor 51 of the server 50 that receives the payment command via the communication interface 54 starts an information processing procedure illustrated in a flowchart of FIG. 20. The processor 51 acquires the cart ID from the payment command, as ACT 121. Then, the processor 51 retrieves the cart management table 522 and confirms whether or not the status ST correlated with the cart ID is “1” indicating under-registration, as ACT 122. Incidentally, when it is confirmed that the status ST is other than “1”, it is an error indicating that payment is instructed from other than the cart terminal 10 which is under registration. In this case, the processor 51 determines that the determination result in ACT 122 is NO, and proceeds to ACT 123. The processor 51 controls the communication interface 54 to transmit an error response command to the cart terminal 10 which is the payment command transmission source, as ACT 123. Thus, the processor 51 ends the payment command reception process. The error response command is wirelessly transmitted from the access point 30 as described above, and is received by the cart terminal 10 which is the registration start command transmission source.

When it is confirmed that the status is “1”, the processor 51 determines that the determination result in ACT 122 is YES, and proceeds to ACT 124. The processor 51 changes the status ST to “2” indicating waiting-for-payment, as ACT 124.

The processor 51 further retrieves the cart management table 522 and checks the warning flag F1 correlated with the cart ID, as ACT 125. Here, when the warning flag F1 is “0”, that is, when no warning is generated, the processor 51 determines that the determination result in ACT 125 is YES, and proceeds to ACT 126. The processor 51 selects the payment machine 40 that performs payment, as ACT 126. For example, when only one of the three payment machines 40 is available, the processor 51 selects the payment machine 40. For example, when two or three payment machines 40 are available, the processor 51 selects any one payment machine 40 according to the priority order. When all the payment machines 40 are used, the processor 51 selects the payment machine 40 that started payment the earliest. The algorithm for selecting the payment machine 40 is not particularly limited.

When the selection of the payment machine 40 is completed, the processor 51 sets the payment machine ID of the selected payment machine 40 in the area of the payment machine ID correlated with the cart ID of the cart management table 522, as ACT 127. The processor 51 controls the communication interface 54 to transmit a first permission response command to the cart terminal 10 which is the payment command transmission source, as ACT 128.

The first permission response command is transmitted from the communication interface 54 to the access point 30 via the network 60, further wirelessly transmitted from the access point 30, and received by the cart terminal 10 which is the registration start command transmission source. The payment machine ID is included in the first permission response command.

On the other hand, when the warning flag F1 is “1”, that is, when a warning is generated, the processor 51 determines that the determination result in ACT 125 is NO, and proceeds to ACT 129. The processor 51 acquires guidance data, as ACT 129. The guidance data is, for example, data of content that guides a customer to offer to the attendant M2 because self-payment is not allowed. The guidance data is stored in the auxiliary storage device 53, for example.

When the guidance data is acquired, the processor 51 controls the communication interface 54 to transmit a second permission response command to the cart terminal 10 which is the payment command transmission source, as ACT 130. The second permission response command is transmitted from the communication interface 54 to the access point 30 via the network 60, further wirelessly transmitted from the access point 30, and received by the cart terminal 10 which is the registration start command transmission source. The guidance data is included in the second permission response command.

When the transmission of the first permission response command or the second permission response command is completed, the processor 51 ends the payment command reception process.

As such, when the warning flag F1 correlated with the cart ID of the cart terminal 10 for which the payment instruction is issued is “0”, that is, when the first counter N1 and the second counter N2 coincide with each other, the server 50 transmits the first permission response command to the cart terminal 10. In contrast, when the warning flag F1 is “1”, that is, when the first counter N1 and the second counter N2 do not coincide with each other, the second permission response command is sent from the server 50 to the cart terminal 10. The second permission response command includes, for example, guidance data that guides a customer to offer to the attendant M2 because self-payment is not allowed.

Here, the computer including the processor 51 of the server 50 as a main component configures a reception unit configured to receive the payment instruction by executing the processes of ACT 121 and ACT 122 of FIG. 20 in cooperation with the communication interface 54.

The computer configures a permission unit by executing the processes of ACT 125 to ACT 128 of FIG. 20 in cooperation with the communication interface 54. That is, on the condition that the warning flag F1 is “0”, the computer transmits the first permission response command and permits the payment.

The computer configures a control unit by executing the processes of ACT 125, ACT 129, and ACT 130 of FIG. 20 in cooperation with the communication interface 54. That is, when the warning flag F1 is “1” and it is determined to notify, the computer controls the notification by outputting the guidance data to the cart terminal 10

Description will be made by referring back to FIG. 13. The processor 11 of the cart terminal 10 that controls the transmission of the payment command waits for a response command. When the response command is received via the wireless unit 14, the processor 11 confirms whether or not the response command is the first permission response command, as ACT 22. When it is confirmed that the response command is not the first permission response command, the processor 11 determines that the determination result in ACT 22 is NO, and proceeds to ACT 23. The processor 11 confirms whether or not the response command is the second permission response command, as ACT 23. When it is confirmed that the response command is also not the second permission response command, that is, an error response command, the processor 11 determines that the determination result in ACT 23 is NO, and performs an error process. The error process includes a process of displaying guidance indicating that the operation of the payment button is an error.

When it is confirmed that the response command is the first permission response command, the processor 11 determines that the determination result in ACT 22 is YES, and proceeds to ACT 24. The processor 11 displays, on the touch panel 15, guidance for notifying the customer to perform payment with the payment machine 40 of the payment machine ID included in the first permission response command, as ACT 24. The processor 11 waits to receive a payment start command, as ACT 25. The payment start command is a command output from the server 50 to the cart terminal 10 when payment is started by the payment machine 40 identified by the payment machine ID.

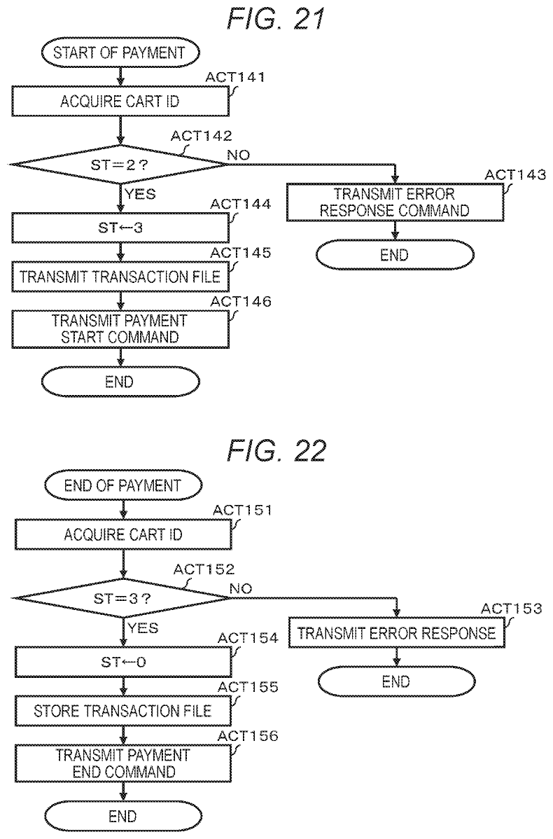

FIG. 21 is a flowchart illustrating an information processing procedure executed by the processor 51 of the server 50 that receives the payment start command from the payment machine 40. The payment start command includes the cart ID of the cart terminal 10 used by the customer who performs payment with the payment machine 40 and the payment machine ID of the payment machine 40.

The processor 51 acquires the cart ID from the payment start command, as ACT 141. Then, the processor 51 retrieves the cart management table 522 and confirms whether or not the status ST correlated with the cart ID is “2” indicating waiting-for-payment, as ACT 142. Incidentally, when it is confirmed that the status ST is other than “2”, it is an error that the customer M1 who uses the cart terminal 10, which is not waiting for the payment, tries to use the payment machine 40, and thus the processor 51 determines that the determination result in ACT 142 is NO, and proceeds to ACT 143. The processor 51 controls the communication interface 54 to transmit an error response command to the payment machine 40 which is the payment start command transmission source, as ACT 143. Thus, the processor 51 ends the payment start command reception process.

The error response command is transmitted from the communication interface 54 via the network 60 to the payment machine 40 which is the payment start command transmission source.

When it is confirmed that the status ST is “2”, the processor 51 determines that the determination result in ACT 142 is YES, and proceeds to ACT 144. The processor 51 changes the status ST to “3” indicating under-payment, as ACT 144. The processor 51 controls the communication interface 54 to transmit data of the transaction file 521 in which the cart ID acquired from the payment start command is set to the payment machine 40 which is the payment start command transmission source, as ACT 145. The processor 51 controls the communication interface 54 to transmit the payment start command to the cart terminal 10 for which the corresponding cart ID is set, as ACT 146. Thus, the processor 51 ends the payment start command reception process.

The payment start command is transmitted from the communication interface 54 to the access point 30 via the network 60, and further wirelessly transmitted from the access point 30. The payment start command is received by the cart terminal 10 for which the cart ID acquired from the payment start command from the payment machine 40 is set.

On the other hand, the data in the transaction file 521 is transmitted from the server 50 to the payment machine 40. In the payment machine 40, a payment process is executed based on the data in the transaction file 521. The payment process is a process for making a settlement with a settlement method such as cash settlement, credit card settlement, electronic money settlement, or the like for the total amount of money of transaction data.

Description will be made by referring back to FIG. 13. When the payment start command is received, the processor 11 determines that the determination result in ACT 25 is YES, and proceeds to ACT 26. The processor 11 commands the camera controller 19 to stop the camera 18, as ACT 26. The processor 11 waits to receive a payment end command, as ACT 27. The payment end command is a command which is output from the server 50 to the cart terminal 10 when the payment process is completed by the payment machine 40 identified by the payment machine ID.

FIG. 22 is a flowchart illustrating an information processing procedure executed by the processor 51 of the server 50 that receives the payment end command from the payment machine 40. The payment end command includes the payment machine ID of the payment machine 40 and the cart ID of the cart terminal 10 used by the customer who completes payment with the payment machine 40.

The processor 51 acquires the cart ID from the payment end command, as ACT 151. Then, the processor 51 retrieves the cart management table 522 and confirms whether or not the status ST correlated with the cart ID is “3” indicating under-payment, as ACT 152. Incidentally, when it is confirmed that the status ST is other than “3”, it is an error indicating that a payment end command is output from the payment machine 40 which is not allowed to start payment. In this case, the processor 51 determines that the determination result in ACT 152 is NO, and proceeds to ACT 153. The processor 51 controls the communication interface 54 to transmit an error response command to the payment machine 40 which is the payment end command transmission source, as ACT 153. Thus, the processor 51 ends the payment end command reception process.

The error response command is transmitted from the communication interface 54 via the network 60 to the payment machine 40 which is the payment end command transmission source.

When it is confirmed that the status ST is “3”, the processor 51 determines that the determination result in ACT 152 is YES, and proceeds to ACT 154. The processor 51 changes the status ST to “0” indicating waiting, as ACT 154. The processor 51 stores data of the transaction file 521, in which the cart ID acquired from the payment end command is set, in the auxiliary storage device 13 as paid data, as ACT 155. The processor 51 controls the communication interface 54 to transmit the payment end command to the cart terminal 10 in which the cart ID is set, as ACT 156. Thus, the processor 51 ends the payment end command reception process.

The payment end command is transmitted from the communication interface 54 to the access point 30 via the network 60, and further wirelessly transmitted from the access point 30. Then, the payment end command is received by the cart terminal 10 for which the cart ID acquired from the payment end command from the payment machine 40 is set.

Description will be made by referring back to FIG. 13. When the processor 11 receives the payment end command, the processor 11 determines that the determination result in ACT 27 is YES, and proceeds to ACT 28. The processor 11 performs initialization of the memory or the like as ACT 28. With the initialization, the cart terminal 10 enters a waiting state. Thus, the processor 11 ends the process of “Process 2”.

When it is confirmed that the response command is the second permission response command, the processor 11 determines that the determination result in ACT 23 is YES, and proceeds to ACT 29. The processor 11 displays guidance notifying the customer to go to the attendant counter AT on the touch panel 15 based on the guidance data included in the second permission response command, as ACT 29. The processor 11 commands the camera controller 19 to stop the camera 18, as ACT 30. Thus, the processor 11 ends the process of “Process 2”.

As such, when the payment button is touched on the cart terminal 10 of the cart ID for which the warning flag F1 is “0”, that is, the first counter N1 and the second counter N2 coincide with each other, the payment machine 40 is notified to the customer from the server 50. Accordingly, the customer M1 can go to the location of the notified payment machine 40 and perform payment.

In contrast, when the warning flag F1 is “1”, that is, the payment button is touched on the cart terminal 10 of the cart ID for which the first counter N1 and the second counter N2 do not coincide with each other, the customer M is notified from the server 50 to go to the attendant counter AT. Accordingly, the customer M1 goes to the attendant counter AT and receives collation work by the attendant M2. The collation work is work for collating data of the commodity registered by the customer him/herself with the commodity in the shopping basket SB.

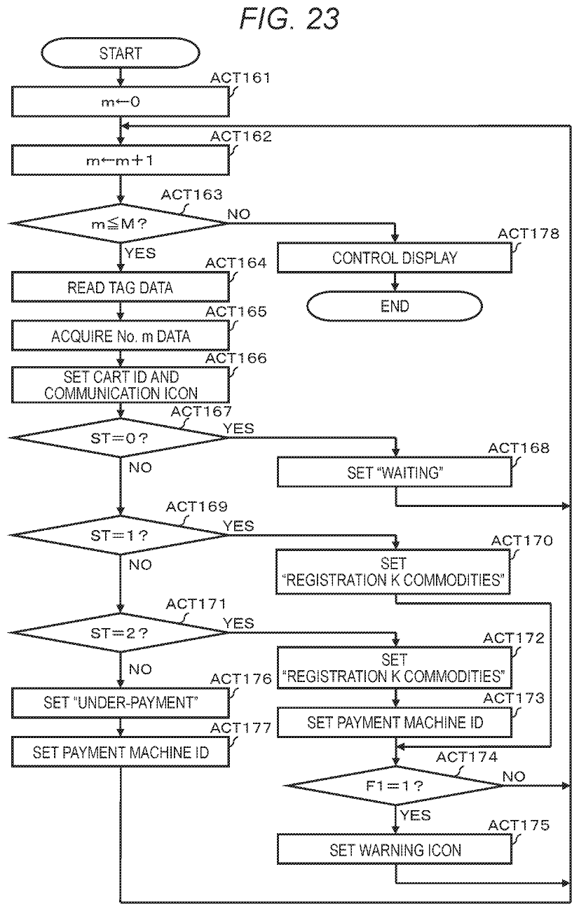

As illustrated in FIG. 9, the cart terminal monitoring image SC1 is displayed on the touch panel 25 of the monitoring terminal 20 in the attendant counter AT. The image data of the cart terminal monitoring image SC1 is generated by the server 50, downloaded to the monitoring terminal 20, and displayed on the touch panel 25. Next, a procedure in which the processor 51 of the server 50 generates image data of the cart terminal monitoring image SC1 will be described with reference to the flowchart of FIG. 23.

FIG. 23 is a flowchart illustrating the main procedure of a timer interrupt process executed by the processor 51 of the server 50. For example, every time the processor 51 receives a timer interrupt signal repeatedly generated at a cycle of 1 second or less, the processor 51 starts an interrupt process of the procedure illustrated in the flowchart of FIG. 23.

The processor 51 resets a number counter m to “0”, as ACT 161. The number counter m is provided in the volatile area of the main memory 52. The processor 51 counts up the number counter m by “1”, as ACT 162. Then, the processor 51 confirms whether or not the number counter m is equal to or smaller than a table number maximum value M of the cart management table 522, as ACT 163.

When it is confirmed that the number counter m is equal to or smaller than the table number maximum value M, the processor 51 determines that the determination result in ACT 163 is YES, and proceeds to ACT 164. The processor 51 reads format data of the tag 70, as ACT 164. The format data is stored in the auxiliary storage device 53, for example.

The processor 51 acquires data whose table number coincides with the number counter m from the cart management table 522, as ACT 165. Then, the processor 51 sets the cart ID of this data and the communication icon 741 in the format data of the tag 70, as ACT 166.

The processor 51 confirms whether or not the status ST of the data is “0”, as ACT 167. When it is confirmed that the status ST is “0”, the processor 51 determines that the determination result in ACT 167 is YES, and proceeds to ACT 168. The processor 51 sets the data “waiting” indicating that waiting is in progress in the format data of the tag 70, as ACT 168. Thereafter, the processor 51 returns to ACT 162.

When it is confirmed that the status ST is not “0”, the processor 51 determines that the determination result in ACT 167 is NO, and proceeds to ACT 169. The processor 51 confirms whether or not the status ST is “1”, as ACT 169. When it is confirmed that the status ST is “1”, the processor 51 determines that the determination result in ACT 169 is YES, and proceeds to ACT 170. The processor 51 sets data “registered k commodities” indicating that registration is in progress in the format data of the tag 70, as ACT 170. Here, “k” is the value of the first counter N1. Thereafter, the processor 51 proceeds to ACT 174. The processes of ACT 174 and subsequent ACTs will be described later.

When it is confirmed that the status ST is not “1”, the processor 51 determines that the determination result in ACT 169 is NO, and proceeds to ACT 171. The processor 51 confirms whether or not the status ST is “2”, as ACT 171. When it is confirmed that the status ST is “2”, the processor 51 determines that the determination result in ACT 169 is YES, and proceeds to ACT 170. The processor 51 sets the data “registered k commodities” indicating waiting-for-payment in the format data of the tag 70, as ACT 172. The data “registered k commodities” is the same as the data “registered k commodities” indicating under-registration. The processor 51 sets the payment machine ID in the format data of the tag 70. The payment machine ID is the payment machine ID determined by the process of ACT 106 in FIG. 18. Thereafter, the processor 51 proceeds to ACT 174.

That is, when the data “registered k commodities” indicating under-registration is set in the format data of the tag 70 in ACT 170, or when the data “registered k commodities” indicating waiting-for-payment and the payment machine ID are set in the same format data in ACT 172 and ACT 173, the processor 51 proceeds to ACT 174. The processor 51 checks the warning flag F1, as ACT 174. When the warning flag F1 is reset to “0”, the processor 51 determines that the determination result in ACT 174 is NO, and returns to ACT 162.

When the warning flag F1 is set to “1”, the processor 51 determines that the determination result in ACT 174 is YES, and proceeds to ACT 175. The processor 51 sets the warning icon 751 in the format data of the tag 70, as ACT 175. Thereafter, the processor 51 returns to ACT 162.

When it is confirmed that the status ST is not “2”, that is, “3”, the processor 51 determines that the determination result in ACT 171 is NO, and proceeds to ACT 176. The processor 51 sets data “under-payment” indicating that payment is in progress in the format data of the tag 70, as ACT 176. The processor 51 sets the payment machine ID in the format data of the tag 70, as ACT 177. The payment machine ID is the payment machine ID determined by the process of ACT 106 in FIG. 18. Thereafter, the processor 51 returns to ACT 162.

In this way, the processor 51 repeatedly executes the processes of ACT 164 to ACT 177 every time the number counter m is counted up by “1”. When the number counter m exceeds the table number maximum value M, the processor 51 determines that the determination result in ACT 163 is NO, and proceeds to ACT 178. The processor 51 generates image data of the cart terminal monitoring image SC1 in which a plurality of tags 70 generated by the processes of ACT 164 to ACT 177 are arranged and downloads the image data to the monitoring terminal 20, as ACT 178.

Thus, on the touch panel 25, the cart terminal monitoring image SC1 in which the plurality of tags 70 respectively corresponding to the cart terminals 10 are arranged is displayed. In this cart terminal monitoring image SC1, the warning icon 751 is displayed in the tag 70 of the cart terminal 10 in which the warning flag F1 is “1”, that is, the first counter N1 and the second counter N2 do not coincide with each other.

Here, the computer including the processor 51 of the server 50 as a main component configures a notification unit by executing the processes of ACT 174 and ACT 175 of FIG. 23. That is, the computer controls the notification that the first counter N1 and the second counter N2 do not coincide with each other by displaying the warning icon 751 on the tag 70 of the cart terminal 10 when the warning flag F1 is “1”.

The attendant M2 monitoring the cart terminal monitoring image SC1 can easily know that the number of commodities registered in the cart terminal 10 on which the warning icon 751 is displayed may not coincide with the number of commodities stored in the cart C. Since, for the customer who uses such the cart C, the payment machine is not notified even if the payment instruction is issued and the guidance for notifying the customer to go to the attendant counter AT is displayed, the attendant M2 can reliably perform the collation work described above. Accordingly, it is possible to prevent the commodity which is not correctly registered at the sales floor from passing through the cash register without being paid for.

In the collation work, the attendant M2 selects and operates the tag 70 in which the cart ID of the cart terminal 10 used by the customer M1 is set. Then, the computer including the processor 51 of the server 50 as a main component displays the list image SC2 of the commodities registered in the cart terminal 10 on the touch panel 25 (output unit). Accordingly, the attendant M2 may collate the commodities in the list image SC2 with the commodities in the shopping basket SB. Therefore, the collation work is simple and a burden required for the work is small.

The server 50 acquires the number of commodities stored in the shopping basket SB from the image captured by the camera 18 provided in the cart C. The camera 18 is originally provided in the cart C in order to confirm whether or not the customer correctly stores the commodity in the shopping basket SB. Accordingly, it is not necessary to provide the cart C with special hardware for acquiring the number of commodities stored in the shopping basket SB.

Although the embodiment of the information processing apparatus that can prevent the commodity which is not correctly registered at the sales floor from passing through the cash register without being paid for is described as above, the embodiment is not limited thereto.

In the embodiment described above, the case where the number of commodities stored in the storing body is acquired from the image captured by the camera 18 as the first acquisition unit is exemplified. The first acquisition unit is not limited thereto. For example, every time a commodity is stored in the storing body, the total weight of the commodities stored in the storing body increases. Alternatively, every time a commodity is taken out from the storing body, the total weight of the commodities stored in the storing body decreases. Then, the number of commodities stored in the storing body may be acquired from the number of times of increase and decrease of the total weight (a scale as the second sensor, the second input device).

In the embodiment described above, a store where the customer M1 uses the cart C to shop is targeted, the scanner 16 provided in the cart C is an example of the specifying unit, and the camera 18 is an example of the image-capturing unit. In this regard, an unmanned or manned store where the customer M1 whose behavior is tracked by a behavior tracking unit uses a mobile terminal such as a smartphone for shopping may be targeted. In this case, it is determined whether or not to issue a warning by comparing the number of commodities registered in the mobile terminal with the number of commodities assumed to be stored in a shopping bag or the like by behavior tracking.

In the embodiment described above, it is determined to notify when the number of commodities acquired by the first acquisition unit and the number of commodities acquired by the second acquisition unit do not coincide with each other. In this regard, for example, when the number of commodities acquired by the first acquisition unit and the number of commodities acquired by the second acquisition unit coincide with each other, for example, payment permission may be notified. In this case, the attendant M2 performs a collation process for the customer who is notified of the payment permission.

In the embodiment described above, the server 50 is described as having all functions as an information processing apparatus. In this regard, the server 50 may not have all the functions as the information processing apparatus. For example, the cart terminal 10 may respectively include the first counter N1 and the second counter N2 to have functions as the first acquisition unit and the second acquisition unit. Alternatively, the cart terminal 10 can be configured to have all functions as an information processing apparatus. Similarly, the monitoring terminal 20 can have at least a part of the functions as an information processing apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processing circuit having programmed instructions to:
acquire a first number of commodities specified to be purchased based on first data acquired by a first sensor;
acquire a second number of commodities stored in a storing body that stores commodities to be purchased based on second data acquired by a second sensor;
compare the first number of commodities with the second number of commodities; and
provide a notification to a display device in response to the first number of commodities being different than the second number of commodities.

2. The information processing apparatus of claim 1, wherein the processing circuit has programmed instructions to provide a list of commodities specified by the first sensor to the display device.

3. The information processing apparatus of claim 1, wherein the second sensor is a camera device positioned to facilitate acquiring an image regarding the second number of commodities stored in the storing body.

4. The information processing apparatus of claim 1, wherein the second sensor is a weight scale positioned to facilitate acquiring a weight regarding the second number of commodities stored in the storing body.

5. The information processing apparatus of claim 1, wherein the first sensor is a scanner.

6. The information processing apparatus of claim 1, further comprising a server that includes the processing circuit.

7. The information processing apparatus of claim 6, further comprising a shopping cart that includes the storing body, the first sensor, the second sensor, and a wireless transmitter for communicating with the server.

8. The information processing apparatus of claim 7, further comprising a monitoring terminal that includes the display device and a wireless transmitter for communicating with the server.

9. The information processing apparatus of claim 7, wherein the shopping cart includes the display device.

10. The information processing apparatus of claim 1, further comprising a shopping cart that includes the storing body, the first sensor, the second sensor, the display device, and the processing circuit.

11. The information processing apparatus of claim 1, further comprising a server and a shopping cart, wherein the shopping cart includes the storing body, the first sensor, the second sensor, and the display device, and wherein the processing circuit includes first components positioned at the remote server and second components positioned on the shopping cart.

12. The information processing apparatus of claim 1, wherein the processing circuit has programmed instructions to:
receive a payment instruction; and
permit payment on condition that the first number of commodities and the second number of commodities coincide with each other when the payment instruction is received.

13. A method for self-registration of commodities, the method comprising:
acquiring a first number of commodities specified to be purchased based on first data acquired by a first input device;
acquiring a second number of commodities stored in a storing body that stores commodities to be purchased based on second data acquired by a second input device;
comparing the first number of commodities with the second number of commodities;
receiving a payment instruction; and
permitting payment on condition that the first number of commodities and the second number of commodities coincide with each other when the payment instruction is received.

14. The method of claim 13, further comprising providing a notification to a display device in response to the first number of commodities being different than the second number of commodities.

15. A customer registration system comprising:
a cart terminal configured to couple to a shopping cart, the cart terminal comprising:
a scanner configured to scan commodities desired to be purchased by a customer;
a sensor configured to monitor the commodities placed into the shopping cart by the customer; and
a display device; and
a processing circuit having programmed instructions to:
acquire a first number of commodities desired to be purchased based on first data acquired by the scanner;
acquire a second number of commodities stored in the shopping cart based on second data acquired by the sensor;
compare the first number of commodities with the second number of commodities; and
provide a notification to the display device in response to the first number of commodities being different than the second number of commodities.

16. The customer registration system of claim 15, wherein the sensor is a camera device configured to facilitate acquiring an image regarding the second number of commodities stored in shopping cart.

17. The customer registration system of claim 15, wherein the sensor is a weight scale configured to facilitate acquiring a weight regarding the second number of commodities stored in the shopping cart.

18. The customer registration system of claim 15, further comprising a server that includes the processing circuit.

19. The customer registration system of claim 15, wherein the cart terminal includes the processing circuit.

20. The customer registration system of claim 15, further comprising a server, wherein the processing circuit includes first components positioned at the remote server and second components positioned at the cart terminal.
